(19) United States
(12) Patent Application Publication
(10) Pub. No.: US 2018/0009288 A1
(43) Pub. Date: Jan. 11, 2018

(54) USER DEMANDED CLIMATE CONTROL IN A VEHICLE

(71) Applicant: Ford Global Technologies, LLC, Dearborn, MI (US)

(72) Inventors: Navneet Bhasin, Preston (AU); Aurelien Lagrandcourt, Preston (AU)

(21) Appl. No.: 15/629,212

(22) Filed: Jun. 21, 2017

(30) Foreign Application Priority Data
Jul. 8, 2016 (CN) 201610539086.4

(51) Int. Cl. B60H 1/00; F24F 11/00

(52) U.S. Cl. CPC B60H 1/00742; B60H 1/00871; F24F 11/0034

(57) ABSTRACT

A climate control system in a vehicle comprises a first vent unit adjacent to a driver seat; a second vent unit adjacent to a passenger seat; a climate control device configured to provide conditioned air to an occupant compartment; and a user input device to enable selection of a first climate control mode or a second climate control mode by a user. The conditioned air passes through the first vent unit at the first climate control mode and the conditioned air passes through the first and second vent units at the second climate control mode.

### RELATED APPLICATION

This application claims the benefit of Chinese Patent Application No.: CN 201610539086.4 filed on Jul. 8, 2016, the entire contents thereof being incorporated herein by reference.

### FIELD

The disclosure related to systems and methods to enable a user to select a climate control mode in a vehicle via a user input device.

### BACKGROUND

A climate control system in a vehicle can provide climate control at different zones of the vehicle such as a zone surrounding a driver side or a zone covering an entire occupant compartment. The climate control in different zones is usually achieved by manual control of the vent units that provide conditioned air to the occupant compartment. The climate control in different zones can be controlled automatically. For example, U.S. Pat. No. 5,878,809 discloses that an individual air-conditioning outlet is controlled as a function of the vehicle seat occupancy in an air-conditioning system. A seat occupancy sensing system is used to detect the presence or absence of a passenger in a seat and a signal is sent to a controller to operate the air-conditioning outlets depending on the received signal. However, the inventors have recognized some issues with the air-conditioning system in U.S. Pat. No. 5,878,809. For example, the seat occupancy sensing system adds costs. Further, some passengers may not want the conditioned air provided by the air-conditioning system.

### SUMMARY

According to one aspect of the present disclosure, a climate control system in a vehicle is provided. The climate control system may comprise a first vent unit adjacent to a driver seat; a second vent unit adjacent to a passenger seat; a climate control device configured to provide conditioned air to an occupant compartment; and a user input device to enable selection of a first climate control mode or a second climate control mode by a user. The conditioned air may pass through the first vent unit at the first climate control mode and the conditioned air may pass through the first and second vent units at the second climate control mode.

In one embodiment, the second vent unit may include vanes and an actuator configured to move the vanes for closing and opening an air passage in the second vent unit in response to the user's selection.

In another embodiment, the user input device may be a button disposed at an instrumental panel and electrically communicated with the actuator, and the air passage in the second vent unit may be closed when the button is set at the first climate control by the user.

In another embodiment, the climate control system may further comprise a controller to control the actuator in response to a user's selection of the first climate control mode or the second climate control mode. The air passage in the second vent unit is closed by the actuator when the user selects the first climate control

In another embodiment, the climate control system may further comprise a controller to control a climate device in response to a user's selection of the first climate control mode or the second climate control mode. The air may be directed only to the first vent at the first climate control mode, and the air may be directed to both the first vent unit and the second vent units at the second climate control mode.

In another embodiment, the user input device may be a human machine interaction (HMI) device having a user interface.

In another embodiment, the climate control system may further comprise a third vent unit adjacent to a first rear passenger seat and a fourth vent unit adjacent to a second rear passenger seat. The user input device may enable the selection of the first climate control mode, second climate control mode, or additional climate control modes by the user.

In another embodiment, the HMI device may include a display, and the display may show a climate control pattern. The climate control pattern may include a seat arrangement and a symbol representing air provision to facilitate the user's selection of the climate control mode.

In another embodiment, the additional climate control modes may include a third climate control mode wherein the conditioned air is provided to the first and second vent units; a fourth climate control mode wherein the conditioned air is provided to the first, second and third vent units; a fifth climate control mode wherein the conditioned air is provided to the first and third vent units; a sixth climate control mode wherein the conditioned air is provided to the first and fourth vent units; and a seventh climate control mode wherein the conditioned air is provided to the first, third and fourth vent units.

According to another aspect of the present disclosure, a climate control system in a vehicle may comprise a user input device; a climate control device configured to provide conditioned air to an occupant compartment; and a controller to control provision of the conditioned air. The conditioned air may pass through driver-side vent units and passenger-side vent units when a driver selects a full climate control mode via the user input device and passes through the driver-side vent units at a driver side climate control mode when the driver selects the driver side climate control mode via the user input device.

In one embodiment, the conditioned air may be directed to the driver-side vent units and the passenger-side vent units by a directing blower of the climate control device at the full climate control mode, and the conditioned air may only be directed to the driver-side vent units by the directing blower at the driver only climate control mode.

In another embodiment, the controller may be configured to close all passenger-side vent units via actuators at the driver only climate control mode and to open the passenger-side vent units at the full climate control mode.

In another embodiment, the climate control system may be configured to set up the provision of the conditioned air at the driver only climate control when the vehicle starts.

According to another aspect, a method to operate a climate control system in a vehicle is provided. The method may comprise generating conditioned air; providing the conditioned air to a first vent unit in response to selection of a first climate control mode via a user input device by a user; and providing the conditioned air to the first vent unit and a second vent unit in response to selection of a second climate control mode via the user input device by the user.

In one embodiment, the first vent unit is adjacent to a driver seat and the second vent unit is adjacent to a front passenger seat. Providing the conditioned air to the first vent unit may include only directing the conditioned air to the first vent unit at the first climate control mode and directing the conditioned air to the first and second vent units at the second climate control mode.

In another embodiment, providing the conditioned air in response to the selection of the first climate control unit may include closing the second vent unit by an actuator upon a driver's selection of the first climate control mode.

In another embodiment, the climate control system may further include a third vent unit and a fourth vent unit which are adjacent to rear seat passengers; and the method may include providing the conditioned air to at least one of the first, second, third and fourth vent units upon the driver's selection of the first climate control mode, the second climate control mode and additional climate control modes. The conditioned air may pass through predetermined vent units at the additional climate control modes.

In another embodiment, the user input device may be a button disposed on an instrumental panel of the vehicle.

In another embodiment, the user input device may be a human machine interaction (HMI) device in the vehicle.

In another embodiment, the method may further comprise operating the vehicle at the first climate control mode when the vehicle starts.

### BRIEF DESCRIPTION OF THE DRAWINGS

Example embodiments will be more clearly understood from the following brief description taken in conjunction with the accompanying drawings. The accompanying drawings represent non-limiting, example embodiments as described herein.

FIG. 1 is a schematic top view of a four-seat passenger vehicle, illustrating an environment in which an example climate control system of the present disclosure may be implemented.

FIG. 2 is a perspective view of an example vent unit in which illustrative embodiments of the present disclosure may be implemented.

FIG. 3 shows an example instrumental panel according to one embodiment of the present disclosure.

FIG. 4 shows another example instrumental panel according to one embodiment of the present disclosure.

FIG. 5 is a schematic block diagram of an example climate control system according to the present disclosure.

FIG. 6 is a flowchart of a method 200 to operate a climate control system in a vehicle according to an example embodiment of the present disclosure

FIG. 7 illustrates an example display on a user input device of climate control modes according to the present disclosure.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. The use of similar or identical reference numbers in the various drawings is intended to indicate the presence of a similar or identical element or feature.

### DETAILED DESCRIPTION

Example embodiments of the present disclosure will now be described more fully with reference to the accompanying drawings, in which example embodiments are shown. Example embodiments of the present disclosure may, however, be embodied in many different forms and should not be construed as being limited to the embodiments set forth herein, rather, these embodiments are provided so that this disclosure will be thorough and complete, and will fully convey the concept of example embodiments to those of ordinary skill in the art.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof

Unless otherwise defined, all terms (including technical and scientific terms) used herein have the same meaning as commonly understood by one of ordinary skill in the art to which example embodiments of the inventive concepts belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

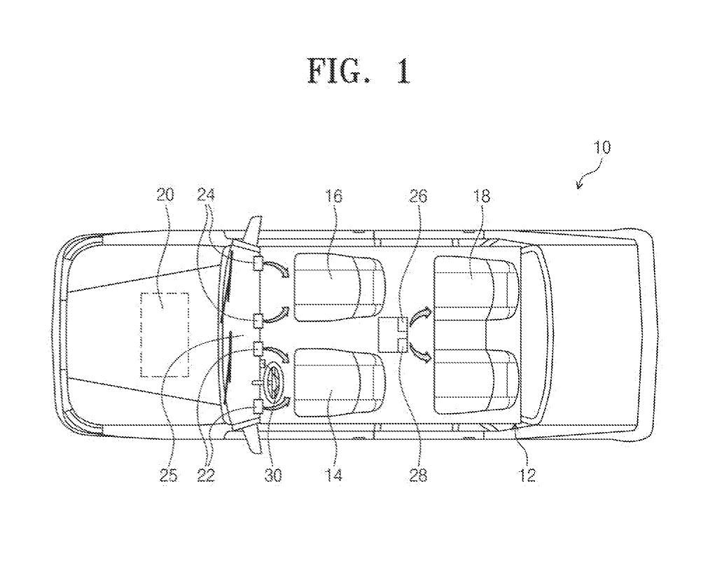

FIG. 1 is a schematic top view of a four-seat passenger vehicle 10, illustrating an environment in which an example climate control system of the present disclosure may be implemented. The vehicle 10 may include an occupant compartment 12, a driver seat 14 and a front passenger seat 16, and a rear passenger seat 18 which are disposed in the occupant compartment 12. The vehicle 10 may further include a climate control system 20 or a heating ventilation, and air conditioning (HVAC) system. The HVAC system may clean, cool, heat, regulate, ventilate and dehumidify the air entering the cabin based on the inputs of a user as well as electronic sensors. The HVAC system may include a climate control device that provides conditioned air. The climate control device may include an A/C evaporator core and the heater core. The air may be set to correct temperature after passing through the A/C evaporator core and the heater core and then delivered as the conditioned air to the occupant compart 12 via vent units.

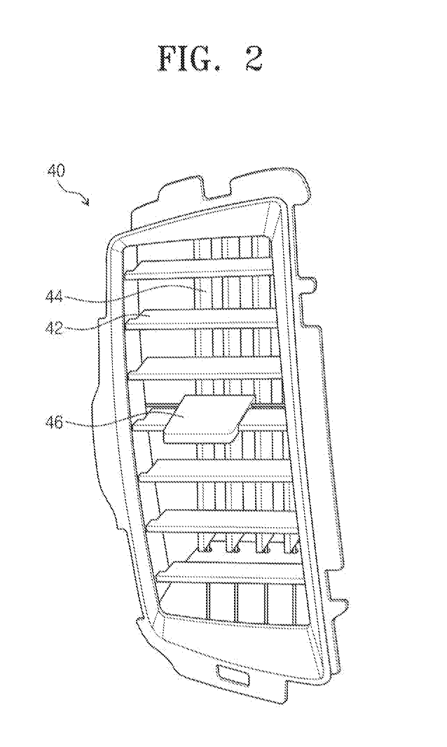

In some embodiments, the vehicle 10 may include a first vent unit 22 and a second vent unit 24 disposed on an instrumental panel 25. The first vent unit 22 may include at least one driver-side vent unit to deliver the conditioned air to the driver. In the depicted embodiment, the first vent unit 22 includes two vent units. The second vent unit 24 may include at least one front passenger-side vent unit to deliver the conditioned air to the passenger sitting at the front passenger seat 16. In the depicted embodiment, the second vent unit 24 includes two vent units. In some embodiments, the vehicle 10 may further include a third vent unit 26 and a fourth vent unit 28 or the rear seat vent units to deliver the conditioned air to the passengers sitting at the rear passenger seat 18. In some embodiments, the third and fourth vent units may be disposed on a rear side of a central console. The vent units 22, 24, 26 and 28 may include vanes that can open and close an air passage from the vent units to the occupant compartment 12 and/or change a direction of airflow as described in detail in FIG. 2.

The climate control system 20 may be operated at different climate control modes. In some embodiments, the climate control system 20 may be operated at a first climate control mode and a second climate control mode. At the first climate control mode, the conditioned air may only pass through the vents or air passages of the driver-side vent unit 22. That is, the heating and cooling may be specific to the driver or the first climate control mode is a driver only climate control. At the second climate control mode, the air may pass through the vents or the air passages of both the driver-side vent units and the passenger-side vent unites. The conditioned air after heating and cooling may be provided to the entire occupant compartment 12 or the second climate control mode may be a full climate control. It should be noted that the air and the conditioned air are used interchangeably to refer to the air passing through the HVAC system and delivered to the occupant compartment 12 via vent units in this disclosure.

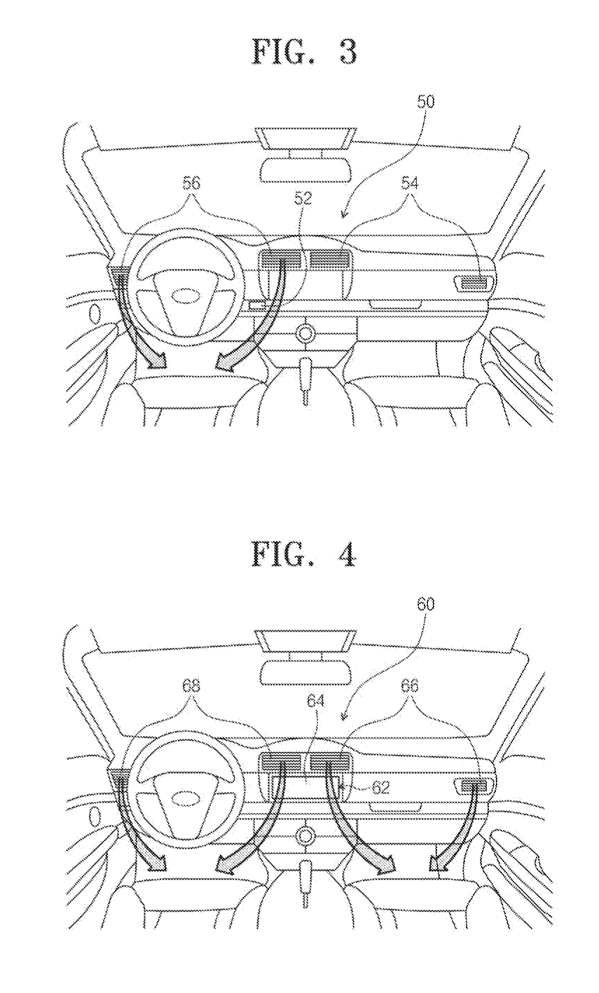

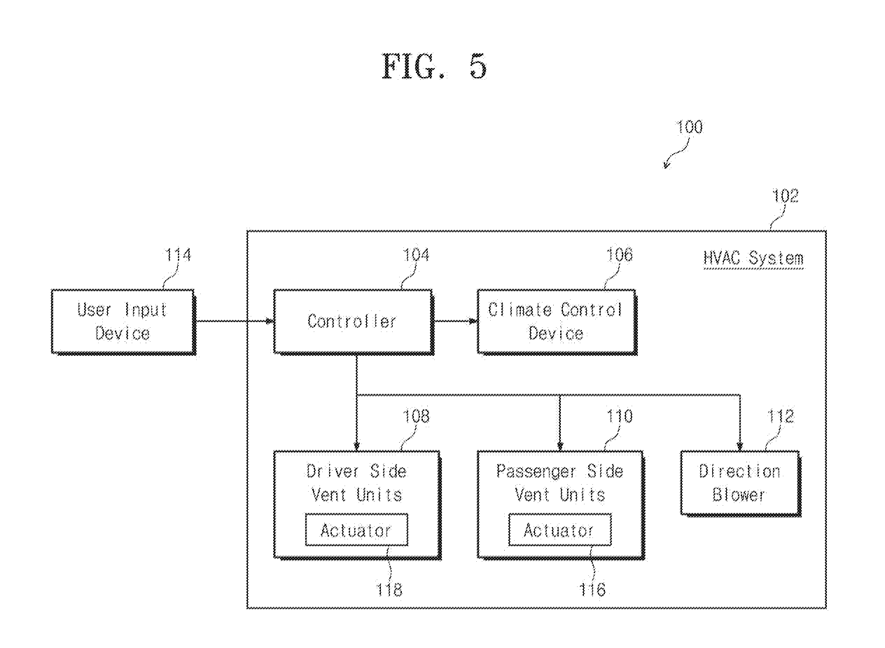

The switching between the first and second climate control modes may be controlled by a driver using a user input device 30 of the climate control system 20. The user input device 30 may be a button disposed on an instrumental panel as illustrated in FIG. 3 for example or may be a user interface of a human and machine interaction (HMI) device as illustrated in FIG. 4 for example. As the driver is the person who operates the car, the user input device 30 enables the driver in control of the climate in the vehicle by selecting the climate control mode depending on the occupancy of the vehicle and/or the requirements of the passengers. With the user input device 30, the need for the driver to manually close and open the passenger-side vent units can be eliminated, and thus creates good user experience. Since the driver only climate control mode provides a localized climate control, less conditioned air is required, which results in less fuel/energy consumption. Further, the fast heating or cooling can be achieved at this mode because the temperature of a smaller zone needs to be adjusted. The system with driver demanded climate control is simple in system design, cost effective and user-friendly.

In some embodiments, the vehicle may have the first, second, third and fourth vents units as illustrated in FIG. 1 and the climate control system 20 may have a plurality of climate control modes configured for a plurality of zones in the occupant compartment according to the occupancy of the passengers and/or requirement of the passengers. For example, the climate control system 20 may include a first climate control mode to provide the conditioned air to a zone surrounding the driver seat and a second climate control mode to provide the conditioned air to a full zone of the occupant compartment 12. Additionally, the climate control system 20 may include at least one of a third, fourth, fifth, sixth and seventh climate control modes. At the third climate control mode, the air may pass through the first vent units 22 and the second vent units 24. The third climate control mode may be selected in a circumstance where only one passenger is present in the vehicle and sits at the front seat 16 or where one or more rear seat passengers are present but they do not want the conditioned air. At the fourth climate control mode, the air may pass through the first vent units 22, the second vent units 24 and the third vent unit 26. The fourth climate control mode may be selected in a circumstance where a passenger sits at the front passenger seat 16 and a passenger sits at the rear passenger seat 18 or where all seats are occupied but a passenger sitting at the rear seat 18 does not want the conditioned air. At the fifth climate control mode, the air may pass through the first units 22 and the third vent unit 26. The fifth climate control mode may be selected in a circumstance where only one passenger sits at the rear passenger seat 18 or where more than one passengers are present but only the passenger sitting near the third vent 26 wants the conditioned air. At the sixth climate control mode, the air may pass through the first vent unit 22 and the fourth vent unit 28. The sixth climate control mode may be selected in a circumstance where only one passenger sits at the rear passenger seat 18 or where more than one passengers are present but only a passenger sitting near the fourth vent 28 wants the conditioned air. At the seventh climate control mode, the air is provided to the first vent units 22, third vent unit 26 and the fourth vent unit 28. The seventh climate control mode may be selected in a circumstance where two passengers sit at the rear seat 18 and there is no front seat passenger or where all seats are occupied but a passenger sitting at the front passenger seat 16 does not want the conditioned air.

The climate control mode may be selected by the driver using the user input device 30. The multiple zone climate control provides the air conditioning to a specific zone and can realize the desired condition or temperature quickly. The climate control system of the present disclosure achieves the customized climate control simply by the driver's selection via the user input device 30. Thus, the climate control based on the occupancy of the passengers and/or the need of the passengers can be achieved while there is no need for adding a seat detecting system or associating the seat detecting system with the climate control system.

FIG. 2 is a perspective view of an example vent unit 40 in which illustrative embodiments of the present disclosure may be implemented. The vent unit 40 may be one of vent units disposed closed to the passenger seats or the vent unit close to the driver seat. The vent unit 40 may include front vanes 42 and rear vanes 44. Both vanes may be adjusted by an adjustment device 46. In some embodiments, the front vanes 42 may be moved to close or open an air passage through the vent and the rear vanes 44 may be adjusted to control a direction of airflow. In some embodiments, both front vanes 42 and the rear vanes 44 may be adjusted for controlling the open/close of the air passage and the direction of airflow. It should be appreciated that any suitable vent units may be used in the implementation of a climate control system of the present disclosure.

A user may move the adjustment device 46 to adjust the amount and/or the direction of airflow passing through the vent unit 40. Additionally, or alternatively, the front vanes 42 may be moved by an actuator such as a motor or a hydraulic driver (not shown) in addition to be moved by the user via the adjustment device 46. In some embodiments, the actuator may be electrically connected to a user input device of a climate control system so that the actuator may close or open the front vane 42 in response to the user's selection of the climate control mode. For example, in one embodiment there are a driver only climate control mode and a full climate control mode and the vent unit is a front seat passenger vent unit, the actuator may close the front vanes when a driver or a user selects a driver only climate control mode and may open the front vane 42 when the driver or the user selects a full climate control mode. In another example, in an embodiment in which there are a plurality of climate control modes and the vent unit 40 is a passenger-side vent unit, the actuator may close the front vanes when the driver or the user select the driver only climate control mode and may open the front vane 42 of a selected vent unit when the driver or the user selects a climate control mode other than the driver only climate control mode. In some embodiments, the actuator may only move the front vanes in response to the driver or the user's input while the position of the rear vane is not changed. In this configuration, the airflow direction remains the same.

It should be appreciated that the actuator is not limited to open and close the front vane 42 of the vent units. For example, the actuator may be configured to open and close the rear vanes that can open and close the air passage to the occupant compartment. In another example, the actuator may be configured to open and close both the front vanes and the rear vanes. In yet another example, the actuator may be configured to open and close both the front vanes 42 and the rear vanes 44, and move both the front vanes and the rear vanes to change the direction of the airflow.

FIG. 3 shows an example instrumental panel 50 in which an example embodiment of the present disclosure may be implemented. As shown in FIG. 3, a user interface device 52 for climate control may be disposed on the instrumental panel 50. In the depicted embodiment, the user interface device 52 is a button. In some embodiments, the button 52 may be configured to have two positions corresponding to a driver only climate control and a full climate control. Upon the user's selection of the driver only climate control, air only passes through the driver-side vent units 56 while air passages of front passenger-side vent units 54 are closed. That is, the air is only provided to a driver seat via the driver-side vent units 56. FIG. 3 shows that upon the user's selection of the driver only climate control mode, the airflow as indicated by an arrow only goes through the driver-side vent units 56.

In some embodiments, a climate control system may have multiple climate control modes and the button 52 may be configured correspondingly to have multiple positions for the user to select the modes. The passenger-side vent units may be opened and closed in response to the driver or the user's selection of the button position.

FIG. 4 shows an example instrumental panel 60 in which an example embodiment of the present disclosure may be implemented. A human machine interaction (HMI) device 62 may be disposed on the instrumental panel 60. The user input device of a climate control system may be the HMI device 62. The HMI device may be a telecommunication and/or a data-processing device permanently or removably installed in a vehicle 12 to provide features such as navigation, entertainment, vehicle information and vehicle control. The climate control features may be implemented in the HMI device 62. The HMI device 62 may include climate control features and a user interface 64 on a touch screen of the HMI device 62 may be used to input, output and display the climate control information. For example, the user interface 64 may present the climate control modes to enable a driver or a user's selection. The driver or the user may select the climate control mode by press or touch the button on the user interface. Upon the driver or the user's input, the climate control system may be operated at a climate control mode selected by the driver or the user. FIG. 4 illustrates an example full climate control mode, in which both driver-side vent units 68 and front passenger-side vent units 66 are open. Air from the climate control system passes through both driver seat vent units 68 and front passenger-side vent units 66.

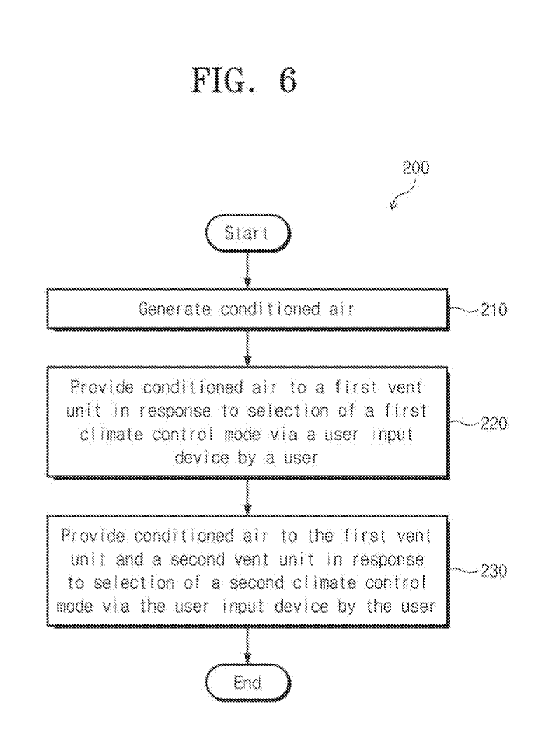

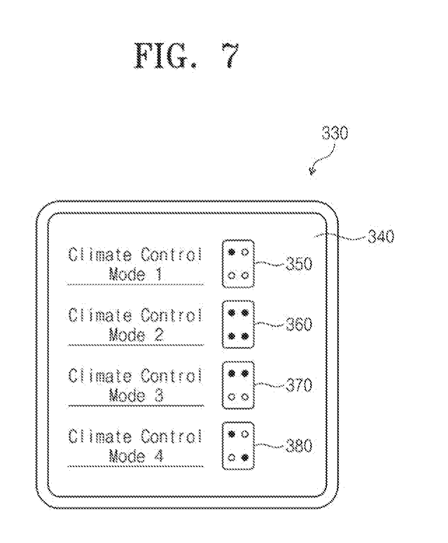

In some embodiments, the climate control system may include two climate control modes such as a driver only climate control and a full climate control. The user interface 64 enables the driver or the user to select the driver only mode or the full climate control mode. In some embodiments, the climate control system may include multiple climate controls that direct air toward different seats. The user interface 64 enables the driver or the user to select one of the climate control modes as described in detail in FIG. 6.

In some embodiments, the operation of the selected climate control mode may be achieved by closing and opening of an air passage via the vanes in the vent units. In some embodiments, the operation of the selected climate control mode may be achieved by directing air flow to the selected vent units via operation of one or more blowers in the climate control system.

FIG. 5 is a schematic block diagram of an example climate control system 100 according to the present disclosure. The climate control system 100 may include a heating, ventilation and air conditioning (HVAC) system 102 that may include a controller 104, a climate control device 106, driver-side vent units 108, passenger-side vent units 110 among other components. The controller 104 may include a processor that provides for computational resources for the climate control system 100 and may serve to execute instructions for software that may be loaded into a memory unit. The instructions may include program code, computer-usable program code, or computer-readable program code. The memory unit may be a storage device that is capable of storing information, such as, without limitation, data, program code in functional form, and/or other suitable information on either a temporary basis and/or a permanent basis.

The driver-side vent units 108 may include two vent units disposed adjacent to a driver seat and the passenger-side units 110 may include two front passenger-side vents. In some embodiments, the passenger-side units 110 may include two rear passenger-side vents in addition to the two front passenger-side vents.

The climate control device 106 may include heating and cooling units that heat, cool and/or dehumidify air passing through the HVAC system 102. For example, the climate control device may include an air conditioning (AC) evaporator and a heater core. In some embodiments, the HVAC system 102 may include a recirculation flap that determines whether air is taken from outside or recirculated from an occupant compartment or taken as a mixed outside air and recirculated air. In some embodiments, the air passes through the air conditioning (AC) evaporator before going through the heater core. The compressor of the AC evaporator may be activated to absorb heat/cool the air when the AC is demanded (e.g., the AC button is on) and the evaporator core does not absorb heat/cool the air when the AC is not in use. After the evaporator core, the air may come to a blend door that determines how much air passing through the heater core that circulates engine coolant. After passing the AC evaporator and the heater core, the air may be heated/cooled to a preset temperature and desired humidity level. In other words, the air is conditioned after passing the climate control device 106.

Among other components, the HVAC system may include a blower that determine an air flowrate or an amount of the air delivered to the occupant compartment. A mode door in the HAVC system 102 may direct air to the driver-side vent units 108, the passenger-side vent units 110, floor vents (not shown) and defrost vents (not shown). An amount and a direction of an airflow passing through a vent unit may be controlled by vanes disposed in the vent units. A driver or a user may manually adjust the positions of the vanes in the vents units to regulate the amount or the direction of airflow passing from the vents. In some embodiments, the HVAC system 102 may include a directing blower 112 to direct the air to the selected vent units. The directing blower 112 may be an individual blower or may be a part of a main blower that serves to direct the airflow to a specific direction.

The climate control system 100 may include a user input device 114 for climate control. The controller 104 may control the HVAC system 102 to operate at different climate control modes in response to a user's demand or input via the user input device 114.

In some embodiments, the climate control system 100 may operate at a driver only climate control mode and a full climate control mode and a driver may select the climate control mode via the user input device 114. Upon receiving the user's input to operate at driver only climate control mode, the controller 104 may close all passenger-side vents 110 so that no conditioned air passes through the passenger side vents 110. In some embodiments, the passenger-side vent units 110 may include an actuator 116 configured to close and open the vanes in the passenger-side vent units 110 by moving the vanes. The controller 104 may be electrically communicated to the actuator 116 and may instruct the actuator 116 to close the passenger-side vents 110 upon the user's selection of the driver only climate control mode. In some embodiments, the controller 104 may communicate electrically with the directing blower 112 and control the directing blower 112 to only direct the airflow to the driver-side vent units 108 upon the user's selection of the driver only climate control mode. In this configuration, the actuator 116 in the passenger-side vent units may not be needed. In some embodiments, the actuator 116 may be communicated electrically with the user input device 114.

In some embodiments, an adjustable climate control mode may be available for the driver to adjust the airflow and/or air direction via the user input device 114. The driver-side vent units 108 may include an actuator 118 to adjust the vanes of in the driver-side vent units 108 to change an amount and/or a direction of the airflow to the driver-side. The controller 104 may be electrically communicated to the actuator 118 and may instruct the actuator 118 to adjust the vanes in response to the user input. In this way, the conditioned air toward the driver may be controlled at a flowrate and/or direction preferred by the driver.

At the driver only climate control mode, other vents such as floor vents and defrost vents may be open and the dehumidification may be operational for interior fogging. Similarly, at the full climate control mode, other vents such as floor vents and defrost vents may be open and the dehumidification may be operational for interior fogging

At the full climate control mode, the conditioned air passes through the driver-side vent units and the passenger-side vent units and a greater amount of conditioned air is provided compared to the driver only climate control mode. In some embodiments, the controller 104 may control the actuators in the passenger-side vent units 110 to open the vanes if the passenger-side vents are close when the full climate control is demanded by the driver. In some embodiments, the controller 104 may instruct the directing blower to deliver the conditioned air to the passenger-side vent units 110 in addition to delivery to the driver-side vents when the full climate control is demanded by the driver.

In some embodiments, the climate control mode may be set up at a driver only control mode when the vehicle is started as the driver is one who operates the vehicle. The driver may select the full climate control mode via the user input device 114 when there are one or more passengers in the vehicle.

In some embodiments, the climate control system may operate at multiple climate control modes and the driver may select the climate control mode via the user input device 114. In addition to the driver only climate control and the full climate control described above, other options are available to provided zoned or localized climate control. In some embodiments, the controller 104 may control the actuators in the passenger-side vent units to close and open the vents in response to the user's selection of the climate control mode. In some embodiments, the controller 104 may control the directing blower 112 to direct the conditioned air passing through one or more passenger-side vents in response to the selection of the full climate control mode.

FIG. 6 is a flowchart of a method 200 to operate a climate control system in a vehicle according to an example embodiment of the present disclosure. At 210, the method 200 includes generating conditioned air. The conditioned air may be generated by a climate control device or a HVAC system as described above. It should be appreciated that the any suitable climate control device or HVAC system may be used. At 220, the method 200 includes providing the conditioned air to a first vent unit in response to selection of at a first climate control mode via a user input device by a user. The user input device may be a button disposed at the instrumental panel or may be an HMI device in the vehicle. A controller of the climate control system may be electrically communicated with the user input device to control provision or delivery of the conditioned air according to the user or the driver's request via the user input device. The first vent unit may be adjacent to a driver seat configured to deliver the conditioned air to a driver. In some embodiments, there may be two vent units adjacent to the driver seats, one at the driver' left and another at the driver's right for example. When the driver selects the first climate control mode, the conditioned air passes through to the first vent unit. In other words, the conditioned air does not pass through the rest of the vent units.

At 230, the method 200 may include providing the conditioned air to the first vent unit and a second vent unit in response to selection of a second climate control mode via the user input device by the user. The second vent unit may include two vent units adjacent to a first passenger seat. In some embodiments, the conditioned air may be directed to both the first and second vent units via a directing blower when the driver selects the second climate control mode. In some embodiments, the vanes in the second vent unit may be opened by an actuator when the driver selects the second climate control mode so that the conditioned air passes through both the first and second vent units.

In some embodiments, the climate control system may further include a third vent unit and fourth vent unit which are adjacent to rear passenger seats. At the second climate control mode, the conditioned air is delivered to the first, second, third and fourth vent units to provide a full climate control. Additionally, or alternatively, the climate control system may include additional climate control modes to deliver the conditioned air to predetermined vent units. The additional climate control modes may include a third climate control mode wherein the conditioned air is provided to the first and second vent units; a fourth climate control mode wherein the conditioned air is provided to the first, second and third vent units; a fifth climate control mode wherein the conditioned air is provided to the first and third vent units; a sixth climate control mode wherein the conditioned air is provided to the first and fourth vent units; 0 and a seventh climate control mode wherein the conditioned air is provided to the first, third and fourth vent units. It should be appreciated that the additional climate control modes described above are example embodiments. Climate control modes may be configured differently. For example, the climate control system may include only the first, second and third climate control modes as described above.

The method described above enables the driver to control the conditioned air to be delivered to a specific zone in the occupant compartment by selecting the climate control mode via the user input device. The user input device allows the driver to select the climate control mode based on the occupancy of the passenger and eliminate the need to have a seat sensing system to determine the occupancy of the seats. Further, the driver can select the climate control mode according to the passenger's requirement for the conditioned air.

FIG. 7 is an example user interface 340 of a user input device 330 of a climate control system in a vehicle according to the present disclosure. The user interface 340 may display a plurality climate control modes for a user's selection. The display may show a climate control pattern including a seat arrangement and a symbol representing an air provision to facilitate the user's selection of the climate control mode. In the example graphic representations, four circles represent the four vent units and a solid circle represents an operation vent unit. The graphic representation 350 indicates a driver-side vent unit is operational at a first climate control mode. The graphic representation 360 indicates that all vent units are operational at a second climate control mode. The graphic representation 370 indicates that the driver-side vent unit and a front passenger-side vent unit are operational at a third climate control mode. The graphic representation 380 indicates that the driver-side vent unit and a rear passenger-side vent unit are operational at a fourth climate control mode. The climate control system may include additional climate control mode (not shown). The user interface 340 allows the user to select appropriate climate control mode based on the occupancy of the vehicle and/or a passenger's need. It should be appreciated that the climate control mode may be illustrated in any suitable manner so that the user can understand the operation of each climate control.

Note that the example control and estimation routines included herein can be used with various engine and/or vehicle system configurations. The specific routines described herein may represent one or more of any number of processing strategies such as event-driven, interrupt-driven, multi-tasking, multi-threading, and the like. As such, various acts, operations, or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated acts or functions may be repeatedly performed depending on the particular strategy being used. Further, the described acts may graphically represent code to be programmed into computer readable storage medium in the engine control system.

It will be appreciated that the configurations and routines disclosed herein are exemplary in nature, and that these specific embodiments are not to be considered in a limiting sense, because numerous variations are possible.

The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application.

The invention claimed is:

1. A climate control system in a vehicle, comprising:
a first vent unit adjacent to a driver seat;
a second vent unit adjacent to a front passenger seat;
a climate control device configured to provide conditioned air to an occupant compartment; and
a user input device to enable selection of a first climate control mode or a second climate control mode by a user, wherein the conditioned air passes through the first vent unit at the first climate control mode and the conditioned air passes through the first vent unit and second vent unit at the second climate control mode.

2. The climate control system of claim 1, wherein the second vent unit includes vanes and an actuator configured to move the vanes for closing and opening an air passage in the second vent unit in response to the user's selection.

3. The climate control system of claim 2, wherein the user input device is a button disposed at an instrumental panel and electrically communicated with the actuator, and wherein the air passage in the second vent unit is closed when the button is set at the first climate control by the user.

4. The climate control system of claim 2, further comprising a controller to control the actuator in response to a user's selection of the first climate control mode or the second climate control mode, wherein the air passage in the second vent unit is closed by the actuator when the user selects the first climate control.

5. The climate control system of claim 1, further comprising a controller to control a climate device in response to a user's selection of the first climate control mode or the second climate control mode, wherein the conditioned air is directed only to the first vent unit at the first climate control mode, and wherein the air is directed to both the first vent unit and the second vent unit at the second climate control mode.

6. The climate control system of claim 5, wherein the user input device is a human machine interaction (HMI) device having a user interface.

7. The climate control system of claim 6, further comprising a third vent unit adjacent to a first rear passenger seat and a fourth vent unit adjacent to a second rear passenger seat, wherein the user input device enables the selection of the first climate control mode, second climate control mode, or additional climate control mode by the user.

8. The climate control system of claim 7, wherein the HMI device includes a display, and the display shows a climate control pattern, and wherein the climate control pattern includes a seat arrangement and a symbol representing air provision to facilitate the user's selection of the climate control mode.

9. The climate control system of claim 8, wherein the additional climate control modes include a third climate control mode wherein the conditioned air is provided to the first and second vent units; a fourth climate control mode wherein the conditioned air is provided to the first, second and third vent units; a fifth climate control mode wherein the conditioned air is provided to the first and third vent units; a sixth climate control mode wherein the conditioned air is provided to the first and fourth vent units; and a seventh climate control mode wherein the conditioned air is provided to the first, third and fourth vent units.

10. A climate control system in a vehicle, comprising:
a user input device;
a climate control device configured to provide conditioned air to an occupant compartment; and
a controller to control provision of the conditioned air in response to a driver's demand via the user input device, wherein the conditioned air passes through driver-side vent units and passenger-side vent units when a driver selects a full climate control mode via the user input device and passes through the driver-side vent units at a driver only climate control mode when the driver selects the driver only climate control mode via the user input device.

11. The climate control system of claim 10, wherein the conditioned air is directed to the driver-side vent units and the passenger-side vent units by a directing blower of the climate control device at the full climate control mode, and the conditioned air is only directed to the driver-side vent units by the directing blower at the driver only climate control mode.

12. The climate control system of claim 10, wherein the controller is configured to close all passenger-side vent units via actuators at the driver only climate control mode and to open the passenger-side vent units via the actuators at the full climate control mode.

13. The climate control system of claim 10, wherein the controller is configured to set up the provision of the conditioned air at the driver only climate control mode when the vehicle starts.

14. A method to operate a climate control system in a vehicle, comprising:
generating conditioned air;
providing the conditioned air to a first vent unit in response to selection of a first climate control mode via a user input device by a user; and
providing the conditioned air to the first vent unit and a second vent unit in response to selection of a second climate control mode via the user input device by the user.

15. The method of claim 14, wherein the first vent unit is adjacent to a driver seat and the second vent unit is adjacent to a front passenger seat, and wherein providing the conditioned air to the first vent unit includes only directing the conditioned air to the first vent unit at the first climate control mode and directing the conditioned air to the first and second vent units at the second climate control mode.

16. The method of claim 14, wherein providing the conditioned air in response to the selection of the first climate control unit includes closing the second vent unit by an actuator.

17. The method of claim 15, the climate control system further includes a third vent unit and a fourth vent unit, wherein the third and fourth vent units are adjacent to rear seat passengers; and wherein the method includes providing the conditioned air to at least one of the first, second, third and fourth vent units upon the driver's selection of the first climate control mode, the second climate control mode and additional climate control modes, wherein the conditioned air passes through predetermined vent units at the additional climate control modes.

18. The method of claim 14, wherein the user input device is a button disposed on an instrumental panel of the vehicle.

19. The method of claim 14, wherein the user input device is a human machine interaction (HMI) device in the vehicle.

20. The method of claim 14, further comprising operating the vehicle at the first climate control mode when the vehicle starts.
